(19) United States
(12) Patent Application Publication
(10) Pub. No.: US 2005/0064752 A1
(43) Pub. Date: Mar. 24, 2005

(54) Ruggedized ethernet connector assembly

(75) Inventor: Donald A. Serino, Plymouth, MA (US)

Correspondence Address: LAHIVE & COCKFIELD, LLP., 28 STATE STREET, BOSTON, MA, 02109, US

(73) Assignee: ALDEN PRODUCTS COMPANY, Brockton, MA (US)

(21) Appl. No.: 10/788,783

(22) Filed: Feb. 27, 2004

Related U.S. Application Data
(60) Provisional application No. 60/450,798, filed on Feb. 28, 2003.

(51) Int. Cl. H01R 13/62

(52) U.S. Cl. 439/320

(57) ABSTRACT

A ruggedized, reliable and sealed connector assembly for the a network, such as the Ethernet, the telephone network, and other applications, includes a housing assembly having push-on, auto-latching connection mechanism that may be used to seal and protect an industry-standard connector. The illustrative connector assembly comprises a first housing assembly for housing a first connector half, such as a jack, and a second housing assembly for housing a second connector half for mating with the first connector half, such as a plug. When the first housing assembly mates with the second housing assembly, the housed plug and jack also mate, in a sealed, protected environment. A locking sleeve is rotated against a spring force during initial insertion of the second housing assembly into the other, and permitted to rotate back into a locking position upon completion of insertion, thereby locking the first housing assembly to the second housing assembly and the first connector half to the second connector half. The first connector half (i.e., a jack) may be removably snapped into place in the first housing assembly and the second connector half (i.e., a plug) may be removably snapped into place in the second housing assembly. The second housing assembly may includes a means for disabling a latching lever arm on a plug component to allow the disengagement and unlocking of the connector assembly by rotating the locking sleeve, rather than requiring manual disengagement of the first and second connector halves.

### RELATED APPLICATION

This application claims priority to, and the benefit of, co-pending U.S. Provisional Application 60/450,798, filed Feb. 28, 2003, for all subject matter common to both applications. The disclosure of said provisional application is hereby incorporated by reference in its entirety.

### FIELD OF THE INVENTION

The present invention relates to an automatically locking connector assembly for joining a first connector body with a second connector body. More particularly, the present invention relates to an automatically locking connector assembly for housing an Ethernet connector.

### BACKGROUND OF THE INVENTION

Modular connectors, such as modular plugs and modular jacks, are commonly used in telecommunications applications, data transmission applications, Ethernet and other network applications. Industry standard connectors include RJ-45 connectors, which are eight-wire connectors used commonly to connect computers onto a local-area network (LAN), particularly the Ethernet, and RJ-11 connectors, used for connecting telephone equipment.

It is generally desirable for a connector to provide flawless electrical contact and mechanical connection throughout a range of conditions. Traditionally, RJ-45 connectors are used in an office or home environment, and are not suitable for hostile environments, such as the factory floor, where they may be exposed to water, dust, humidity, stress, chemicals, dirt, temperature variations, vibration and other elements. While there is a growing need to provide access to information in industrial environments, RJ-45 connectors, and other similar connectors used for Ethernet and other network applications, tend to be delicate, breakable, difficult to connect and disconnect, and subject to degradation and corrosion from exposure to the harsh elements found in an industrial environment. The introduction of the Internet and other applications to the factory floor poses a strong need for Ethernet connectors that can withstand harsh environments and elements found in the industrial setting.

Conventional systems have attempted to protect RJ-45 connectors using silicon gel disposed proximate to the contact interface. However, the silicon gel tends to trap foreign debris, such as dust and dirt, which interfere with proper connectivity. The silicon gel further does not provide protection against other elements, such as chemicals, vibration, shock, and UV light. Other conventional systems for protecting RJ-45 and other connectors require a housing for sealing the connector halves that must integrally formed or molded on the a connector half, such as the jack. The integrated housing prevents removal and replacement of a defective or otherwise unsuitable connector half.

Furthermore, there is often a need to change the numbers, configurations, or sizes of multi-circuit connectors to meet specific needs. Being able to make these changes in the field easily and without special tools is a great advantage to technicians and end users to meet specific and often unique custom connector needs quickly without waiting for the connectors or connector inserts to be manufactured or ordered and shipped to the site.

### SUMMARY OF THE INVENTION

The present invention provides a ruggedized, reliable, and sealed connector assembly for the Ethernet and other applications that can consistently and easily mate and unmate in an industrial setting. The connector assembly includes a housing assembly having a push-on, auto-latching connection mechanism that may be used to seal and protect an industry-standard Ethernet connector. The illustrative connector assembly comprises a first housing assembly for housing a first connector half, such as a jack, and a second housing assembly for housing a second connector half, such as a plug, for mating with the first connector half. When the first housing assembly mates with the second housing assembly, the housed plug and jack also mate, in a sealed, protected environment. To connect the connector assembly, a locking sleeve is rotated against a spring force during initial insertion of the second housing assembly into the other, and permitted to rotate back into a locking position upon completion of insertion, thereby locking the first housing assembly to the second housing assembly and the first connector half to the second connector half. The first connector half (i.e., a jack) may be removably snapped into place in the first housing assembly and the second connector half (i.e., a plug) may be removably snapped into place in the second housing assembly. The second housing assembly may includes a means for disabling a latching lever arm on a plug component to allow the disengagement and unlocking of the connector assembly by rotating the locking sleeve, rather than requiring manual disengagement of the first and second connector halves.

In accordance with one example embodiment of the present invention, a modular network connector assembly includes a first connector housing for housing a first connector half having a first telescoping body portion. A second connector housing has a second telescoping body portion for engaging with the first telescoping body portion, wherein the second connector housing is configured to house a second connector half for axially mating with the first connector half. An annular collar encircles the telescoping body portions and is rotatably held on the second connector housing. A spring is provided inside the collar, the ends of the spring being confined between the second connector housing and the collar so as to yieldingly resist rotation of the collar relatively to the second connector housing. Axially opposed tabs are provided on the collar and first connector housing with opposed flaring cam surfaces cooperatively producing rotation of the collar relative to the first connector housing as the first and second connector housing are telescoped to a mated contact position, the cam surfaces guiding the collar tab around the body tab. The spring yieldes as the collar is rotated by the cam tabs during contact mating, and the spring then rotates the collar tab to a latching position axially behind the body tab locking the first and second connector housings in mated contact position.

In accordance with aspects of the present invention, the modular network connector assembly further includes a first connector half housed in the first connector housing and a second connector half housed in the second connector housing. The first connector half can include a RJ-45 jack and the second connector half can include a RJ-45 plug. The plug can mate with the jack when the first and second connector housings are in the mated contact position. The second connector housing can include a lever disabling groove for disabling a latching lever on the plug when the plug is inserted in the second connector housing.

In accordance with further aspects of the present invention, the first connector housing includes a retaining system for releasably retaining the first connector half therein. The retaining system includes a first groove for engaging a first protrusion on the first connector half. The retaining system further includes a second groove for engaging a second protrusion on the first connector half.

In accordance with further aspects of the present invention, the second connector housing includes a retaining system for releasably retaining the second connector half therein. The retaining system includes a ridge formed in a plug-receiving receptacle of the second connector housing for engaging a groove on the second connector half. The second connector housing includes a threaded portion for engaging a strain relief for a cable. A strain relief can be attached to the threaded portion of the second connector housing. The second connector housing can include a disabling groove for disabling a latching lever arm on the second connector half.

In accordance with one example embodiment of the present invention, a modular network connector assembly includes a plug receptacle sized and configured to receive a plug. A ridge is formed on an inner surface of the receptacle for engaging with a groove in the plug to removably retain the plug in the receptacle.

In accordance with one example embodiment of the present invention, a modular network connector assembly includes a jack housing. A first cavity is formed in the housing for receiving and retaining a jack. A second cavity is formed in the housing for receiving a telescoping portion of a plug housing. A jack retaining system is provided for releasably retaining a jack in the first cavity.

In accordance with one example embodiment of the present invention, a modular network connector assembly includes a plug housing. A plug receptacle is formed in a first end of the plug housing for receiving and retaining a plug. A threaded portion is provided on the second end of the plug housing for mating with a strain relief

### BRIEF DESCRIPTION OF THE FIGURES

The present invention will become better understood with reference to the following description and accompanying drawings, wherein:

FIG. 1 illustrates a conventional network connector comprising a jack and a plug for mating with the jack;

FIG. 2 illustrates a ruggedized network connector assembly according to an illustrative embodiment of the invention;

FIG. 3 illustrates the ruggedized network connector assembly of FIG. 2 in an engaged position;

FIG. 4 is an exploded isometric view of the housing of the ruggedized network connector assembly according to an illustrative embodiment of the invention with first and second connector housings and a collar;

FIG. 5 is an exploded side view, of the first connector housing, collar, and second connector housing of the connector assembly of FIG. 4;

FIG. 6 is a perspective view of the second connector housing for housing a plug according to an illustrative embodiment of the present invention;

FIG. 7 is a cross-sectional side view of the second connector housing of FIG. 6;

FIG. 8 is a perspective view of the first connector housing for housing a jack according to an illustrative embodiment of the present invention;

FIG. 9 is a cut-away view of the first connector housing of FIG. 8; and

FIG. 10 is a perspective view of a jack suitable for insertion into the first connector housing of FIGS. 8 and 9.

### DETAILED DESCRIPTION OF THE INVENTION

The present invention provides a ruggedized, self-latching network connector assembly for conventional network connectors, such as Ethernet and telephonic connectors. The invention will be described below relative to illustrative embodiments. Those skilled in the art will appreciate that the present invention may be implemented in a number of different applications and embodiments and is not specifically limited in its application to the particular embodiments depicted herein.

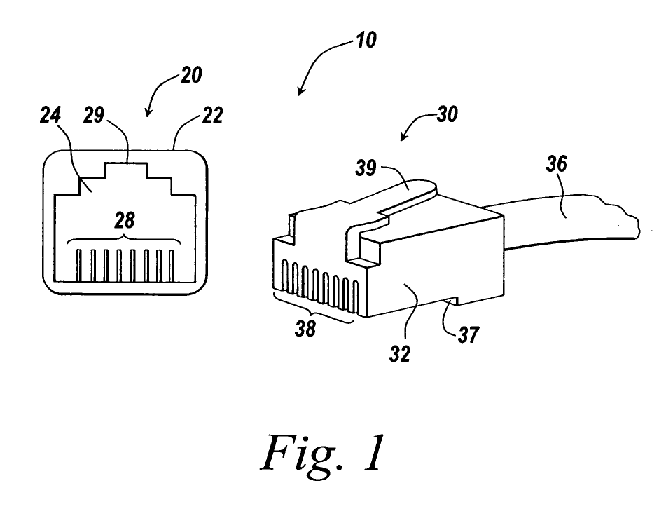

FIG. 1 illustrates a conventional network connector in the form of an Ethernet connector 10 for Ethernet applications, suitable for implementing an illustrative embodiment of the present invention. The illustrative connector 10 is a RJ-45 connector, an eight-wire commonly used for network cabling and for telephony applications, as well as serial connections, though one skilled in the art will recognize that the invention is not limited to using RJ-45 connectors, but can be utilized with a number of different network connectors. As shown, the connector 10 comprises a jack 20 and plug 30 configured to mate with the jack. The jack 12 comprises a housing 22 defining a plug-receiving cavity 24 for receiving the plug body 32. The plug body 32 is adapted to slide into and engage the jack 20, such that the electrical contacts 38 of the plug electrically engage the electrical contacts 28 of the jack. As the plug body slides into the plug-receiving cavity 24 of the jack, a latch, illustrated as a resilient lever arm 39, latches into a latching groove 29 in the jack, which temporarily locks the plug to the jack. The plug 30 is removed by first depressing the resilient lever arm 39 and then pulling the plug 30 from the jack 20.

A cable 36 extends from the wired end of the plug 30. The illustrative RJ-45-type plug has eight leads located side-by-side. Each lead is connected to a wire-connecting portion at one end of the plug, and one of the contacts 38 at a second end of the plug. The RJ-45-type jack 20 also has eight conductive leads typically located side-by-side, and each lead also is connected to a wire connecting terminal at a first end of the jack and to one of the contacts 28 at a second end of the jack. Typically, each of the eight wire connector terminals of the plug are connected to a corresponding conductor of the four twisted pairs of conductors of the cable 36, in a standard arrangement

The standard Ethernet connector 10 is difficult to connect and disconnect, requiring a user to depress the relatively small, delicate lever arm 39 in order to remove the plug from the jack. The connector of FIG. 1 is also not suitable for an industrial environment, as the connector is not protected from dust, humidity, chemicals and other elements and is not robust or capable of withstanding shock, vibration and other stresses. The connector 10 is also difficult to maintain and repair.

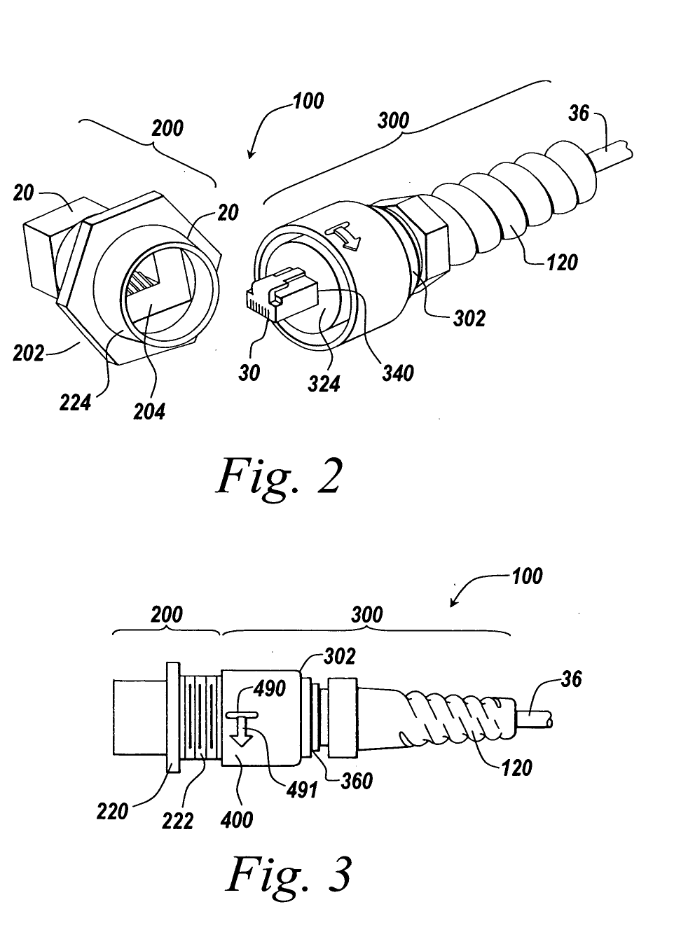

FIG. 2 illustrates an Ethernet connector assembly 100 of an illustrative embodiment of the present invention. The connector assembly 100 comprises a first modular connector assembly, illustrated as a modular jack assembly 200, and a second modular connector assembly, illustrated as modular plug assembly 300, for mating with the first modular connector assembly 200. The illustrative modular jack assembly 200 comprises a first latching connector housing, illustrated as a jack housing 202, that houses a first connector half, illustrated as the jack 20 of FIG. 1. The illustrative modular plug assembly 300 comprises a second latching connector housing, illustrated as plug housing 302, for releasably engaging the first latching connector housing. The housing 302 includes a plug boss 324 defining a plug receptacle 340 that houses a second connector half, illustrated as the plug 30 of FIG. 1. In the illustrative embodiment, the jack 20 and plug 30 are housed in the jack housing 202 and the plug housing 302, respectively, such that when the jack housing 202 engages the plug housing 302, as shown in FIG. 3, the jack 20 and plug 30 also mate.

According to an illustrative embodiment, the housing 202, 302 is formed of thermal plastic to provide a sturdy structure for protecting the connector from elements, such as humidity, chemicals, dust, dirt, water, shock, vibration, and other forces. The connector assembly 100 provides a sealed environment for the jack and plug connection. The illustrative Ethernet connector assembly 100 further provides a self-latching, automatically locking connector that is simple and easy to couple, while providing a secure connection. The illustrative Ethernet connector assembly must be disengaged manually, to prevent accidental disengagement of the assembly 100. An illustrative embodiment of the latching mechanism for latching the illustrative Ethernet connector assembly 100 of an illustrative embodiment of the invention will be described below, though one skilled in the art will recognize that other suitable means for latching together a modular jack assembly and a modular plug assembly may be used in accordance with the teachings of the present invention.

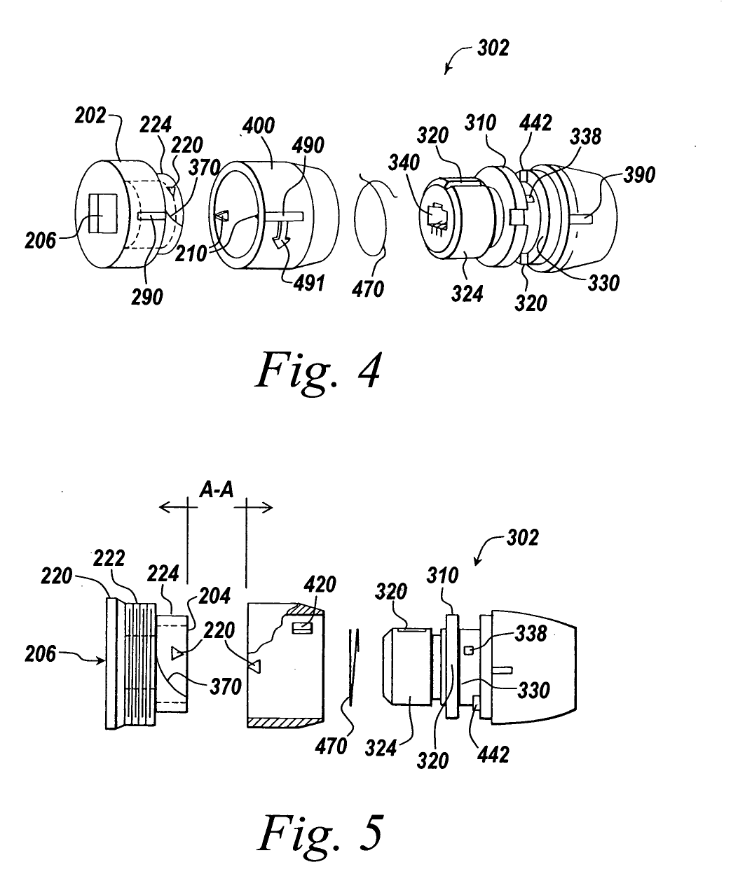

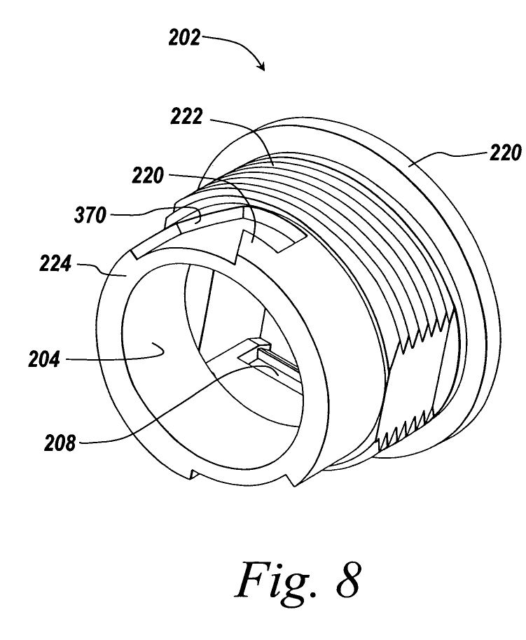

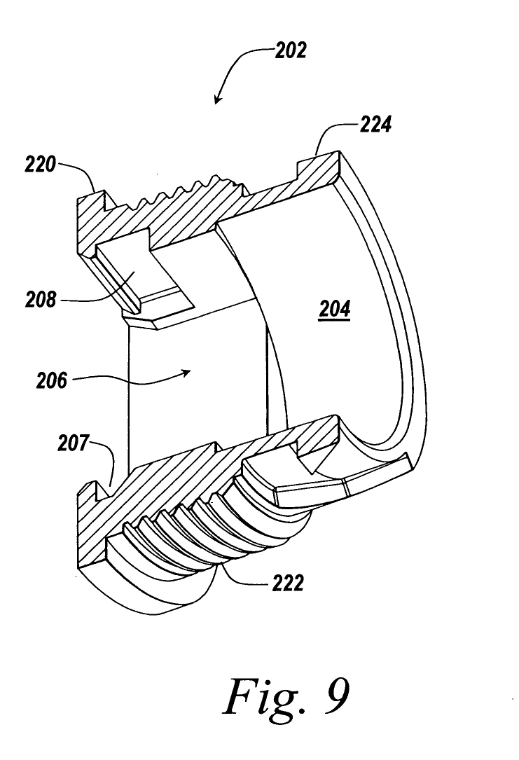

FIGS. 4 and 5 illustrate the jack housing 202 and the plug housing 302 of the connector assembly 100 in an exploded position. The jack may be mounted in a back cavity 206 of the jack housing 202. When assembled, the plug boss 324 telescopes into a front cavity 204 (shown in FIGS. 8 and 9) of the jack housing 202, such that the contacts 38 of the plug 30 axially mate with the contacts 28 of the jack 20 when the jack housing 202 engages the plug housing 302 along the longitudinal axis A-A. The jack housing 202 may further include a flange 220 and threads 222 for mounting the first connector assembly 200 in a panel with a nut or other suitable mating device.

An annular collar 400 is rotatably mounted on the plug boss 324 to latch the connector assemblies 200, 300 together. When the two assemblies 200, 300 are mated, the annular collar 400 encircles the boss 324 of the plug housing 302 and the socket 224 of the jack housing 202 to hold the connector bodies together. As shown, the collar 400 is mounted on the boss 324, such that there is a circumferential space between the inner surface of the collar and the outer surface of the boss 324. According to the illustrative embodiment, the collar 400 includes one or more internal radial stops 420 and the plug housing 302 includes a first flange 310 having one or more passageways 320 extending longitudinally and configured to receive the stops 420 on the collar 400. An annular groove 330 is also formed on the plug housing 302 for receiving the internal radial stops 420 of the collar 400.

The collar 400 is mounted to the plug boss 324 by sliding the collar 400 along the longitudinal axis A-A over the boss 324, such that the internal radial stops 420 on the collar 400 are admitted through the passageways 320 on the plug housing and into the annular groove 330. The annular groove 330 axially confines the stops and holds the collar 400 rotatably around the plug housing 302. The stops limit the amount of rotation of the collar to a range of about forty degrees. One skilled in the art will recognize that other suitable means of rotatably locking the annular collar 400 to the plug housing may be used in accordance with the teachings of the invention.

The collar 400 further includes at least one camming tab 210 configured to engage one or more camming tabs 220 on the first connector housing to lock the connector housing bodies together. According to the illustrative embodiment, the camming tabs 210, 220 comprise opposing, pie-shaped protrusions, though other configurations may be used according to the present invention. The camming tabs 210, 220 comprise opposing points and two camming surfaces flaring away from each point to intersection with a back surface.

A coiled spring 470 may be provided for biasing the collar 400 into a normal position when the collar is mounted on the plug housing. The coiled spring 470, illustrated as a round wire of spring metal, though any suitable mechanism for biasing the collar may be used, is also confined in the annular groove 330 of the plug housing. The spring 470 may be anchored at a first end inside the collar at a first stop 442 and at a second end in a small recess 338 in the groove 330. The spring 470 is biased yieldingly to constantly urge the collar stops 420 to a normal position abutting the opposed stops 442 in the groove 330. In the rest position, as described in detail below, the camming tabs 210 provided on the collar 400 are located relative to the plug-receiving cavity 24 on the jack, such that the collar camming tabs 210 and plug body are in matching alignment with corresponding camming tabs 220 and the plug-receiving cavity 24 on the jack, respectively.

The insulative boss 324 of the first connector body 10 may further include longitudinal keyways (not shown), which receive keys (not shown) formed on an inner surface of the plug-receiving cavity 24 of the jack 20 to assure correct angular alignment during mating engagement.

Index marks may also be provided as a visual aid to the correct angular alignment in alignment of the connector assemblies 200, 300. For example, the illustrative connector system includes a first index mark 490 on the collar 400, a second index mark 290 on the first body and a third index mark 390 on the second body, which align when the connector bodies are properly engaged. The mark 490 on the collar may further include an arrowhead 491 indicating the direction in which the collar 400 can be rotated from the normal position during the two operations of locking engagement and disengagement of the two bodies.

To lock the male and female connector assembly together, the markers 490, 290 on the collar 400 and the first housing 20, respectively, are manually aligned and the two bodies are pushed together along the longitudinal axis A-A to achieve a snap-lock. When the first connector housing and the second connector housing are pushed together, the first connector housing receives the second connector housing, as the boss 324 telescopes in the front cavity 204 of the modular jack assembly. As the boss 324 telescopes into the front cavity 204, the plug 30 slides into and engages the jack 20, such that the electrical contacts 38 of the plug electrically engage the electrical contacts 28 of the jack 20.

At the same time, the camming tabs 210, 220 slide past each other. The collar camming tab 210 is offset a small angle from a central plane through the collar and receptacle to facilitate engagement. After first sliding engagement, the mutual edging action of the camming surfaces forces the collar 400 to rotate against the spring, allowing the collar tab 210 to slide around the receptacle tab 220 and then spring back with its back surface behind the back surface of the receptacle tab 220.

In this position, the tabs lock the first housing 202 to the second housing 302 and the jack 20 to the plug 30. The spring 470 reverses rotation of the collar 400 until the faces of the collar stops strike the opposed faces of the plug stops. An audible “snap” signals that the first housing and the second housing, are locked together and that the jack 20 is effectively mated with the plug 30. Locking may be visually confirmed by alignment of the index marks after the automatic return of the collar to its normal position by the spring.

The connectors may be released manually, by rotating the collar 400. To disengage the connectors, the collar 400 is manually rotated in the direction of the arrowhead 491. The rotation of the collar 400 turns the collar camming tabs 210 towards a circumferential ramp 370 slanting across the paths of the tabs. The camming face of each ramp is angled away from the adjacent tab, so that it cams the collar tab 210, collar 400 and plug housing apart and out of engagement with the jack housing. In this manner, disengagement can be effected without pulling and straining the cord extending from the plug, because the rotation of the collar is in a plane at right angles to the axis of the plug and cord.

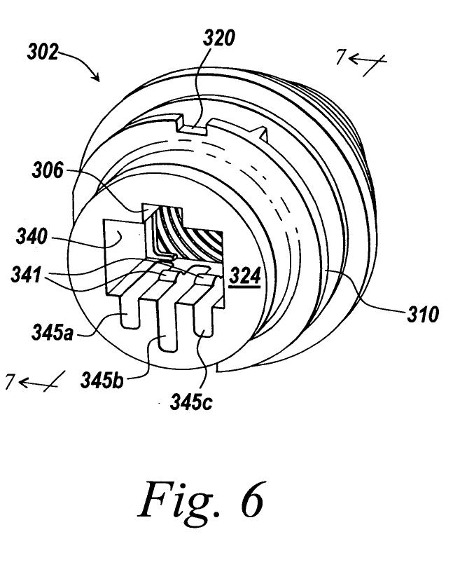

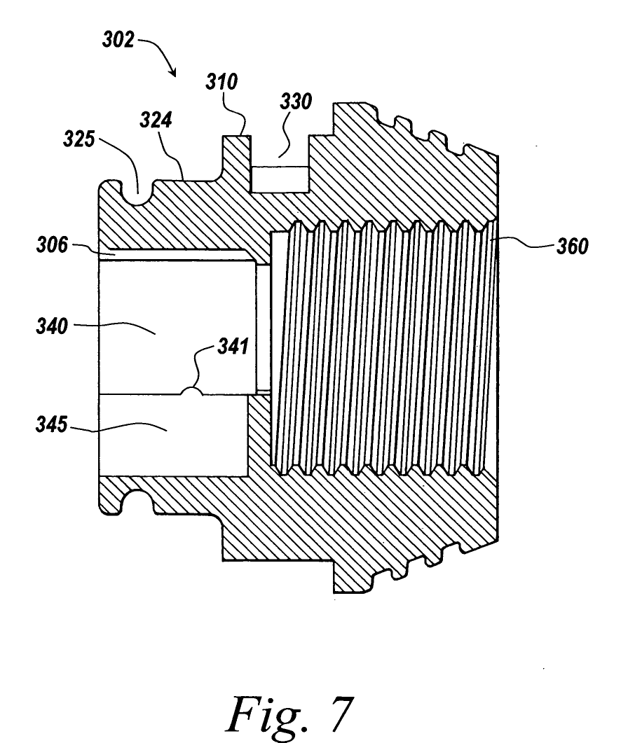

FIG. 6 is a perspective view of the plug housing 302 of the ruggedized connector assembly of an illustrative embodiment of the present invention, wherein the collar 400 is removed. FIG. 7 is a cross-sectional view of the plug housing 302 of FIG. 6. As shown, the plug housing includes an plug receptacle 340 sized and configured for accommodating a connector piece, such as the plug 30. The plug housing 302 is designed such that the connector piece may be easily assembled therein. The plug housing further includes a lever disabling groove 306 for disabling the resilient lever arm 39 of the plug 30 by maintaining the lever in a depressed position when the plug is inserted in the plug receptacle 304. Alternatively, the resilient lever arm 39 of the plug 30 may be removed prior to assembly of the plug assembly 300. In the illustrative embodiment, the plug is mounted in the housing 302 by sliding the plug body into the plug receptacle, such that the groove 306 depresses the lever arm 39. The plug receptacle 340 includes a plug retainer, illustrated as a ridge 341 formed on the lower wall thereof and extending in a direction perpendicular to the longitudinal axis A-A. The ridge 341 engages with a groove in the back of the plug 30 (behind the step 37 shown in FIG. 1) for retaining the plug in the plug housing 302. Alternatively, the plug retainer may comprise a groove or depression formed in a wall of the plug receptacle for engaging a protrusion on the plug. One skilled in the art will recognize that the invention is not limited to the illustrative plug retainer and that any suitable means for retaining the plug in the plug housing may be utilized in accordance with the teachings of the invention, such as friction fit.

The illustrative lever-disabling groove 306 is formed in an upper surface of the plug receptacle 340 for disabling the lever arm 39 of the plug. When the plug 30 is retained in the plug housing 302, the lever-disabling groove 306 maintains the latching lever arm in a depressed position. The disabling of the lever arm 39 allows the plug and jack to be easily coupled and de-coupled through the coupling and de-coupling of the jack housing 202 and plug housing 202, as described above, without requiring a user to activate the cumbersome latch. According to an alternate embodiment, the lever arm of the plug may be simply removed prior to insertion of the plug into the plug receptacle, in order to de-activate the latching mechanism between the plug and jack. One skilled in the art will recognize that any suitable means for de-activating the latching mechanism may be used in accordance with the teachings of the present invention.

According to the illustrative embodiment, the plug housing 302 may further include coring 345, illustrated as three longitudinal grooves 345a, 345b, 345c formed in the lower wall of the plug receptacle 340 for enhancing the seal between the modular jack assembly 200 and the modular plug assembly 300. The illustrative coring 345 allows for expansion of the plug housing 302, for example, due to humidity, temperature changes and/or stresses applied to the housing, without affecting the sealing capabilities of the connector assembly 100. One skilled in the art will recognize that the coring 345 may have any suitable configuration and location for absorbing expansion of the housing 302.

The outer circumference of the boss 324 may include an o-ring groove 325 for receiving an o-ring therein to enhance sealing between the modular jack assembly and the modular plug assembly.

The back side of the plug housing 302 may include threads 360 for accepting an industry standard threaded strain relief (120, shown in FIGS. 2 and 3) for the cable 36.

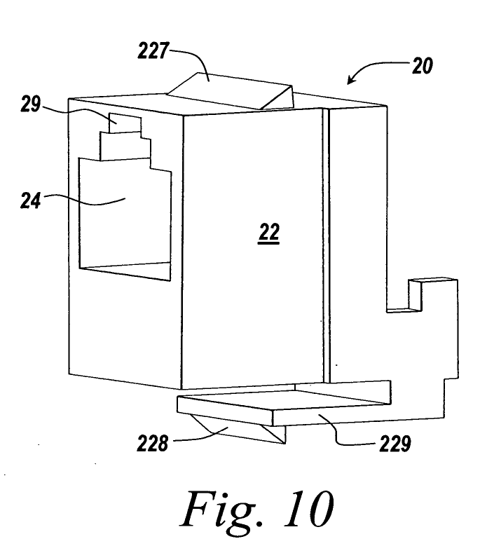

FIG. 8 is a perspective view of the jack housing 202 of the jack assembly 200. FIG. 9 is a cut-away view of the jack housing 202 of FIG. 8. FIG. 10 is a perspective view of the jack 20 suitable for assembly in the jack housing 202 of FIGS. 8 and 9. As shown, the jack housing 202 includes a front cavity 204 defined by the socket 224 for receiving the plug boss 324, and a back cavity 206 for housing a connector piece, such as the jack 20. When a plug boss 324 housing a plug 30, as shown in FIG. 2, is received in the front cavity 204 of the jack housing 202, the plug 30 carried by the plug boss is inserted into a jack 30 housed in the back cavity 206.

The jack housing 202 is configured such that a connector half, such as the jack 30 illustrated in FIGS. 1 and 10, can be easily and removably snapped into the housing. The jack may be retained in the jack housing using a suitable retaining system. According to the illustrative embodiment, the jack housing 202 includes a first jack retainer, illustrated as a first groove 207, and a second jack retainer, illustrated as a second groove 208, formed on opposite sides of the back cavity 206 for retaining the corresponding connector half therein. As shown in FIG. 10, an industry standard jack 20 includes a first protrusion 227 formed on a first side of the jack 20 and a latching lever 229 extending on a second side of the jack and having a second protrusion 228 formed thereon. When the jack 20 is inserted in the back cavity 206, the first groove 207 receives and retains the first protrusion 227 and the second groove 208 receives and retains the second protrusion 228, thereby releasably retaining the jack 20 in the housing 202.

The illustrative retaining system allows a variety of industry standard jacks to be easily snapped into the environmentally sealed housing. The jacks can be easily removed from the housing and replaced. One skilled in the art will recognize that the invention is not limited to the illustrative retaining system and that any suitable means for releasably retaining a connector piece in the housing 202 may be used in accordance with the teachings of the invention.

One skilled in the art will recognize that the present invention is not limited to the illustrated method of coupling the two housing assemblies together and that other suitable means for latching the housing assemblies together may be used in accordance with the teachings of the invention.

One skilled in the art will also recognize that the invention is not limited to RJ-45 connectors and that the connector assemblies 200, 300 may also be used to accommodate other components, such as, but not limited to: fiber-optic, coaxial, pin-and-socket connectors, as well as other telecommunications methodologies, such as RJ-11 connectors and so on.

The ruggedized Ethernet connector assembly provides simple and automatic locking engagement of the first connector assembly to the second connector assembly without deformation of the plastic, insulative connector bodies or collar. Engagement is indicated positively by an audible snap and by alignment of index marks. The spring allows a rotary disengaging manipulation, which is convenient and which places no longitudinal strain on a cord or cable connected to the plug body. The connectors provide a secure connection, while providing an environmentally sealed housing that protects the jack and plug connection from harsh environments. Once mated, the housing will not easily break, de-couple, leak or expose the components to the elements. Furthermore, the housing components may be easily retrofit to existing, standard connectors, such as the RJ-45 jacks and plugs prevalently used today. A user can simply snap a selected industry standard connector half into the housing to assemble the connector assembly. The connector half may be removed from the housing so that the connector half and/or the housing may be used in another application without damaging any of the components.

The present invention has been described relative to an illustrative embodiment. Since certain changes may be made in the above constructions without departing from the scope of the invention, it is intended that all matter contained in the above description or shown in the accompanying drawings be interpreted as illustrative and not in a limiting sense. It should be understood that the present disclosure is for the purpose of illustration only, and that the invention includes all modifications and equivalents falling within the appended claims

It is also to be understood that the following claims are to cover all generic and specific features of the invention described herein, and all statements of the scope of the invention which, as a matter of language, might be said to fall therebetween.

1. A modular network connector assembly comprising:
a first connector housing for housing a first connector half having a first telescoping body portion;
a second connector housing having a second telescoping body portion for engaging with the first telescoping body portion, wherein the second connector housing is configured to house a second connector half for axially mating with the first connector half;
an annular collar encircling the telescoping body portions and rotatably held on the second connector housing,
a spring inside the collar, the ends of the spring being confined between the second connector housing and the collar so as to yieldingly resist rotation of the collar relatively to the second connector housing; and
axially opposed tabs disposed on the collar and first connector housing with opposed flaring cam surfaces cooperatively producing rotation of the collar relative to the first connector housing as the first and second connector housing are telescoped to a mated contact position, the cam surfaces guiding the collar tab around the body tab;
wherein the spring yields as the collar is rotated by the cam tabs during contact mating, and the spring then rotates the collar tab to a latching position axially behind the body tab locking the first and second connector housings in mated contact position.

2. The modular network connector assembly of claim 1, further comprising a first connector half housed in the first connector housing and a second connector half housed in the second connector housing.

3. The modular network connector assembly of claim 2, wherein the first connector half comprises a RJ-45 jack and the second connector half comprises a RJ-45 plug.

4. The modular network connector assembly of claim 3, wherein the plug mates with the jack when the first and second connector housings are in the mated contact position.

5. The modular network connector assembly of claim 3, wherein the second connector housing includes a lever disabling groove for disabling a latching lever on the plug when the plug is inserted in the second connector housing.

6. The modular network connector assembly of claim 1, wherein the first connector housing includes a retaining system for releasably retaining the first connector half therein.

7. The modular network connector assembly of claim 6, wherein the retaining system comprises a first groove for engaging a first protrusion on the first connector half.

8. The modular network connector assembly of claim 7, wherein the retaining system further includes a second groove for engaging a second protrusion on the first connector half.

9. The modular network connector assembly of claim 1, wherein the second connector housing includes a retaining system for releasably retaining the second connector half therein.

10. The modular network connector assembly of claim 9, wherein the retaining system includes a ridge formed in a plug-receiving receptacle of the second connector housing for engaging a groove on the second connector half.

11. The modular network connector assembly of claim 1, wherein the second connector housing includes a threaded portion for engaging a strain relief for a cable.

12. The modular network connector assembly of claim 11, further comprising a strain relief attached to the threaded portion of the second connector housing.

13. The modular network connector assembly of claim 1, wherein the second connector housing includes a disabling groove for disabling a latching lever arm on the second connector half.

14. A modular network connector assembly, comprising:
a plug receptacle sized and configured to receive a plug; and
a ridge formed on an inner surface of the receptacle for engaging with a groove in the plug to removably retain the plug in the receptacle.

15. A modular network connector assembly, comprising:
a jack housing;
a first cavity formed in the housing for receiving and retaining a jack;
a second cavity formed in the housing for receiving a telescoping portion of a plug housing; and
a jack retaining system for releasably retaining a jack in the first cavity.

16. The modular network connector assembly of claim 15, wherein a plug retained in the plug housing mates with a jack mounted in the first cavity when the telescoping portion of the plug housing is inserted in the second cavity.

17. The modular network connector assembly of claim 15, wherein the jack retaining system comprises a first groove formed in the first cavity for engaging a first protrusion on a jack.

18. The modular network connector assembly of claim 17, wherein the jack retaining system further comprises a second groove formed in the first cavity opposite the first groove for engaging a second protrusion on a jack.

19. A modular network connector assembly, comprising:
a plug housing;
plug receptacle formed in a first end of the plug housing for receiving and retaining a plug; and
a threaded portion on the second end of the plug housing for mating with a strain relief.

20. The modular network connector assembly of claim 19, further comprising:
a threaded strain relief mated with the threaded portion of the plug housing.
